(19) United States
(12) Patent Application Publication
(10) Pub. No.: US 2014/0045081 A1
(43) Pub. Date: Feb. 13, 2014

(54) BIFUNCTIONAL ELECTRODE DESIGN AND METHOD OF FORMING SAME

(71) Applicant: pH Matter, LLC, Columbus, OH (US)

(72) Inventors: Paul H. Matter, Columbus, OH (US); Christopher T. Holt, Bexley, OH (US); Michael G. Beachy, Gahanna, OH (US)

(73) Assignee: pH Matter, LLC, Columbus, OH (US)

(21) Appl. No.: 13/963,611

(22) Filed: Aug. 9, 2013

Related U.S. Application Data
(60) Provisional application No. 61/681,954, filed on Aug. 10, 2012.

(51) Int. Cl. H01M 4/86; H01M 4/88

(52) U.S. Cl. CPC H01M 4/8615; H01M 4/88
USPC 429/405; 429/535

(57) ABSTRACT

A method for making a doped carbon bifunctional electrode capable of facilitating the oxygen reduction reaction and the oxygen evolution reaction that is not susceptible to performance degradation when operated bi-functionally for oxygen reduction and evolution.

In one embodiment, a doped carbon catalyst is prepared by mixing a metal precursor with a high surface area support, impregnated with at least one organic phosphorus and/or organic nitrogen compound, and then pyrolyzed at high temperature under an inert or reducing atmosphere containing volatile carbon and/or nitrogen species. The doped-carbon catalyst may be coated on a conductive porous support and dispersed as an ink infiltrated into a porous conductive support.

In another embodiment, a catalyst precursor, such as an iron salt and/or cobalt salt solution mixed with a binder, such as cellulosic binder, is infiltrated into a porous support, and pyrolized such that carbon catalyst fibers are anchored directly on the support.

### CROSS-REFERENCE TO RELATED APPLICATIONS

This application claims the benefit of U.S. Provisional Patent Application 61/681,954; filed Aug. 10, 2012.

### STATEMENT REGARDING FEDERALLY SPONSORED RESEARCH OR DEVELOPMENT

This invention was made with government support under National Science Foundation Contract Number 1142874. The government may have certain rights in the invention.

### TECHNICAL FIELD

The present disclosure relates generally to a method for making a bifunctional doped carbon electrode capable of facilitating the oxygen reduction reaction and the oxygen evolution reaction.

### BACKGROUND OF THE INVENTION

The electrochemical reduction of oxygen to water is a key reaction used in the cathodes of metal-air batteries, fuel cells, and electrolysis cells. In many applications, such as secondary metal-air batteries, regenerative fuel cells, or water electrolysis, it is desirable to have a cathode that also can evolve oxygen when an electrical load is applied to the cell. However, the catalysts required for these reactions typically must contain expensive precious metals, such as platinum, to achieve high performance. Such metals are susceptible to oxidation during oxygen evolution, leading to degraded oxygen reduction performance.

The Oxygen Reduction Reaction (ORR) is an important reaction for a number of electrochemical applications, including metal-air batteries, industrial electrolysis processes, and fuel cells. The oxygen reduction half-cell reaction is shown below for acidic and basic electrolytes, respectively:

(ORR in basic electrolyte) O2+2H2O+4 e−→4 OH− Eo=0.18 V vs. 1 M Ag/AgCl

(ORR in acidic electrolyte) O2+4 H++4 e−→2 H2O Eo=1.01 V vs. 1 M Ag/AgCl

In many applications, it would be desirable to use the same cathode to perform the reverse reaction, known as oxygen evolution reaction (OER). For example, in secondary metal-air batteries, when the battery is recharged, the anode is reduced back to its metallic state, and oxygen is evolved from the cathode. In reversible fuel cells, during energy storage cycles, hydrogen is regenerated on the anode from water, and oxygen is evolved from the cathode. Cathodes that are used for both the ORR and OER are known as bifunctional cathodes. In order to operate electrochemical cells at high efficiency, electro-catalysts must be used in the cathode to improve the kinetics for the ORR and OER. However, the available options for catalysts are inadequate for most applications due to some or all of the following limitations.

Many catalysts show poor activity. Slow kinetics for the ORR and OER create a large overpotential, a drop in voltage before current can be drawn from the cell for discharge cycles, or an increase in the voltage required to generate oxygen for charging cycles. This overpotential reduces cell efficiency, and/or requires higher catalyst loadings to be used.

Many catalysts show poor durability. The metal catalysts typically used in cathodes suffer degradation by several routes. The harsh chemical environment of cells (strong acid or strong base electrolytes) can cause catalyst corrosion through oxidation and/or dissolution of metals. Further, voltage cycling experienced during charging and discharging induces migration of metal particles into the electrolyte.

Many catalysts have high associated costs: The most efficient cathode catalysts are typically based on precious metals, such as platinum, ruthenium, and/or rhodium. Consequently, the high cathode cost prohibits wide-spread adoption of many technologies that require highly efficient bi-functional cathodes.

In the following, we describe various embodiments of a bifunctional catalyst and cathode design, and a method for making the same that can be fabricated from inexpensive precursors, and has superior performance and durability compared to known bifunctional cathode designs.

### SUMMARY OF THE INVENTION

The disclosed invention relates to methods to for making a doped carbon bifunctional electrode capable of facilitating the oxygen reduction reaction and the oxygen evolution reaction. Various embodiments of this invention describe a bi-functional electrode based on doped carbon that is not susceptible to performance degradation when operated bi-functionally for oxygen reduction and evolution.

The bifunctional cathode does not use a conventional supported metal catalyst to derive activity for dual oxygen reduction and oxygen evolution activity. Instead, the cathode is based on doped carbon as a catalyst for the ORR and OER. The doped carbon catalyst is not soluble in electrolytes, and therefore can undergo voltage cycling without significant loss of performance.

In one embodiment, the first step is to prepare a doped carbon catalyst that is active for both the ORR and the OER. In one approach, active doped carbon can be prepared by first mixing a metal precursor, such as iron or cobalt, with a high surface area support, such as carbon black. In embodiment, the pre-cursor is impregnated with at least one organic phosphorus and/or organic nitrogen compound. The precursor is then pyrolyzed at high temperature (400°-1200° C.) under an inert or reducing atmosphere containing volatile carbon and/or nitrogen species. In another embodiment, phosphorus is also added as a volatile pre-cursor during pyrolysis. After the pyrolysis, samples may be subjected to additional processing steps, such as milling, heat treatments, and/or acid washes. Acid washes are generally beneficial for applications where the catalyst will be used in an acidic electrolyte, but are optional for neutral and basic electrolyte applications. Washing may also be required if magnesia were used as the high surface area support for the precursor instead of carbon black. Although phosphorus doping generally increases activity and durability for ORR/OER applications, it is also possible to prepare an active catalyst consisting of nitrogen doped carbon, without significant phosphorus content.

In order to construct a device that can operate at higher current densities, the doped-carbon catalyst is preferably coated on a conductive porous support. In one embodiment, the catalyst can be dispersed with a solvent and binder to form an ink The ink is then coated and/or infiltrated in a porous conductive support, such as carbon fiber paper. The coated/infiltrated paper is hot pressed to remove residual solvent and to bind the catalyst to the carbon fiber paper.

In another embodiment, a catalyst precursor, such as iron salt and/or cobalt salt solution mixed with a binder, such as cellulosic binder, can be infiltrated into a porous support, such as carbon fiber paper, nickel mesh, or steel mesh. The support and precursor can then be subjected to one of the pyrolysis conditions described above to form the active doped carbon catalyst fibers that are anchored directly on the support.

Illustrative examples of various embodiments of the invention, all provided by way of example and not limitation, are described.

### BRIEF DESCRIPTION OF THE ILLUSTRATIONS

Without limiting the scope of the bifunctional electrode as disclosed herein and referring now to the drawings and figures:

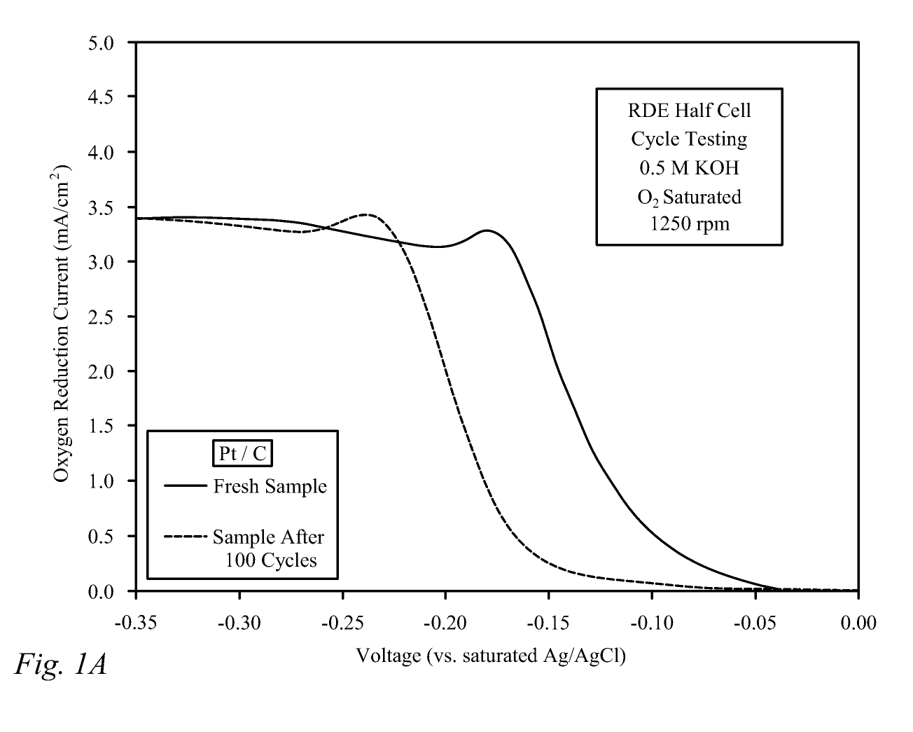

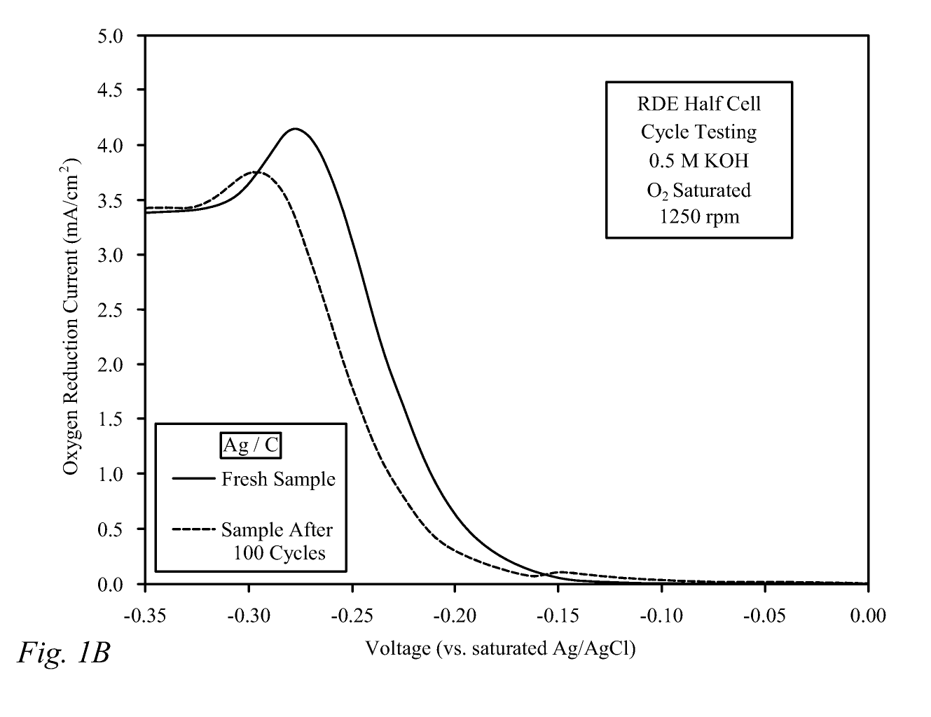

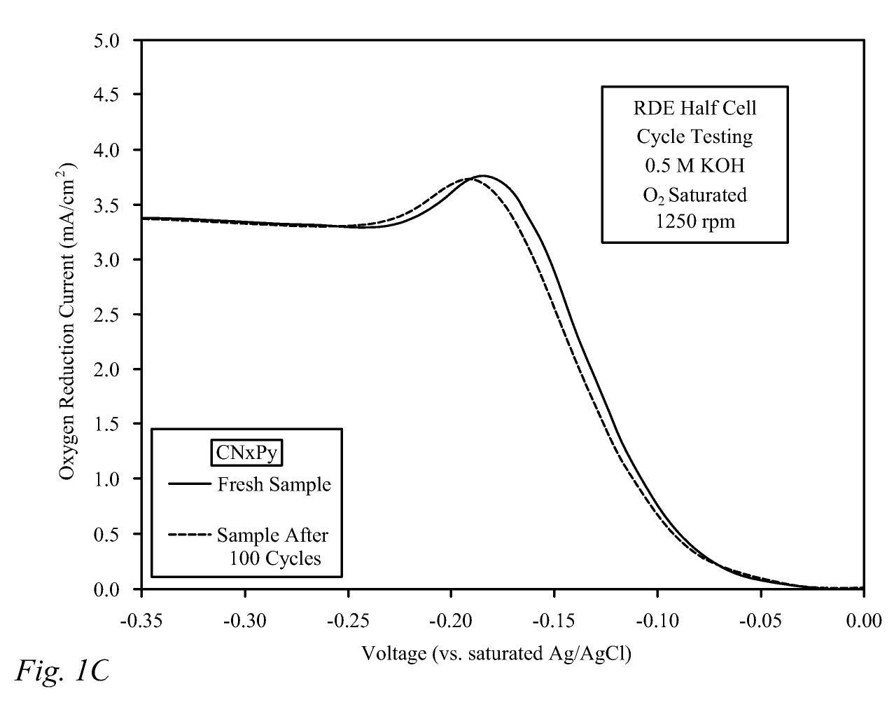

FIGS. 1A-1C show the oxygen reduction current of a CNxPy bifunctional catalyst compared to a standard 20-wt % Pt and a standard 20-wt % Ag catalyst before and after 100 charge/discharge cycles in 0.5 M KOH;

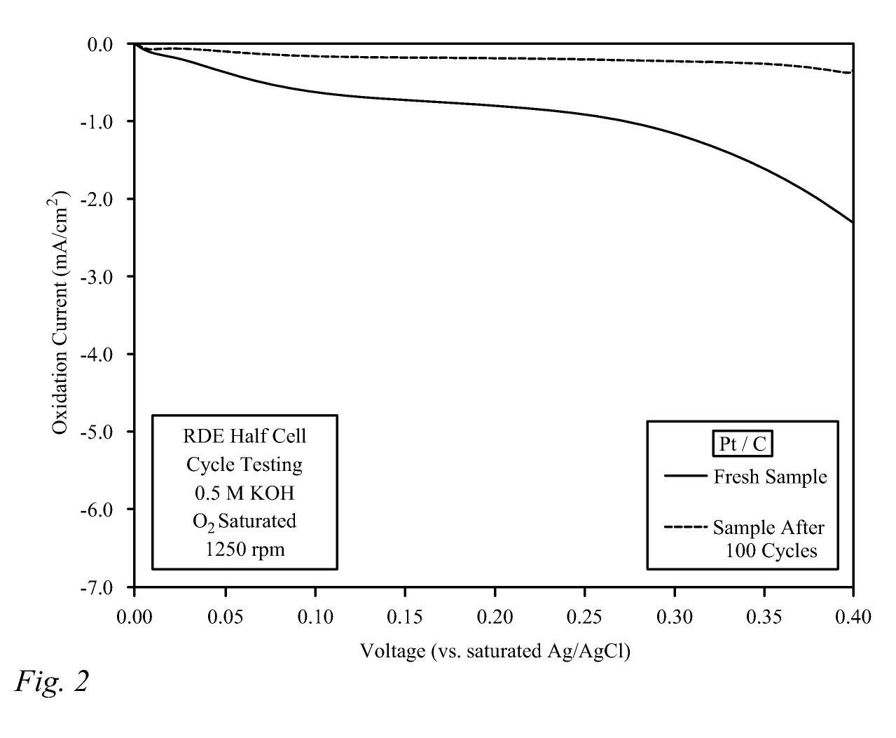

FIG. 2 shows the oxidation current of 20-wt % Pt on Vulcan Carbon during “charge” cycle in 0.5 M KOH before and after 100 charge/discharge cycles;

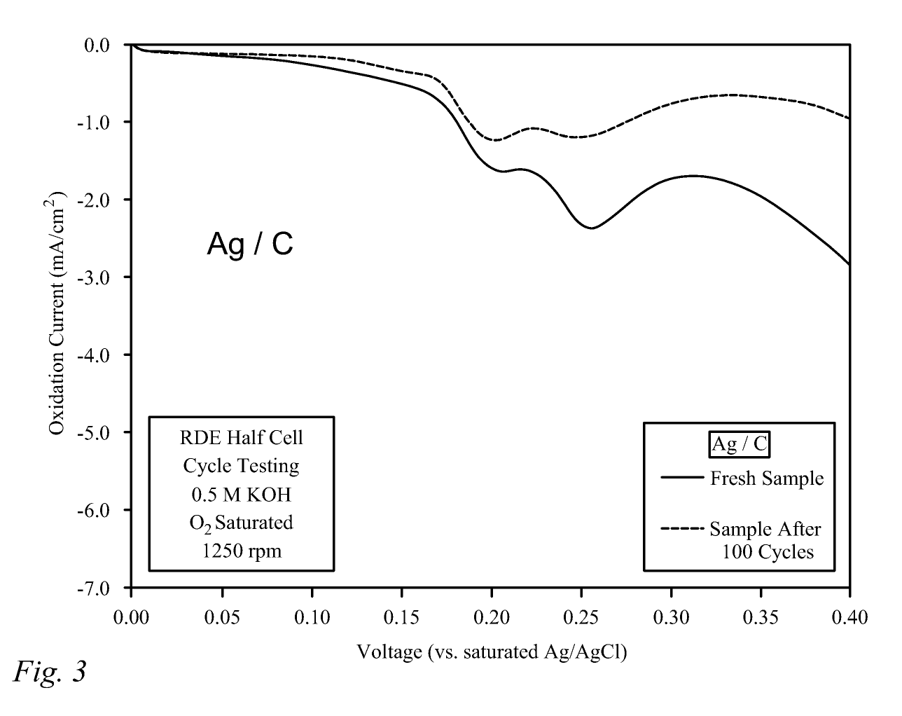

FIG. 3 shows the oxidation current of 20-wt % Ag on carbon black during “charge” cycle in 0.5 M KOH before and after 100 charge/discharge cycles;

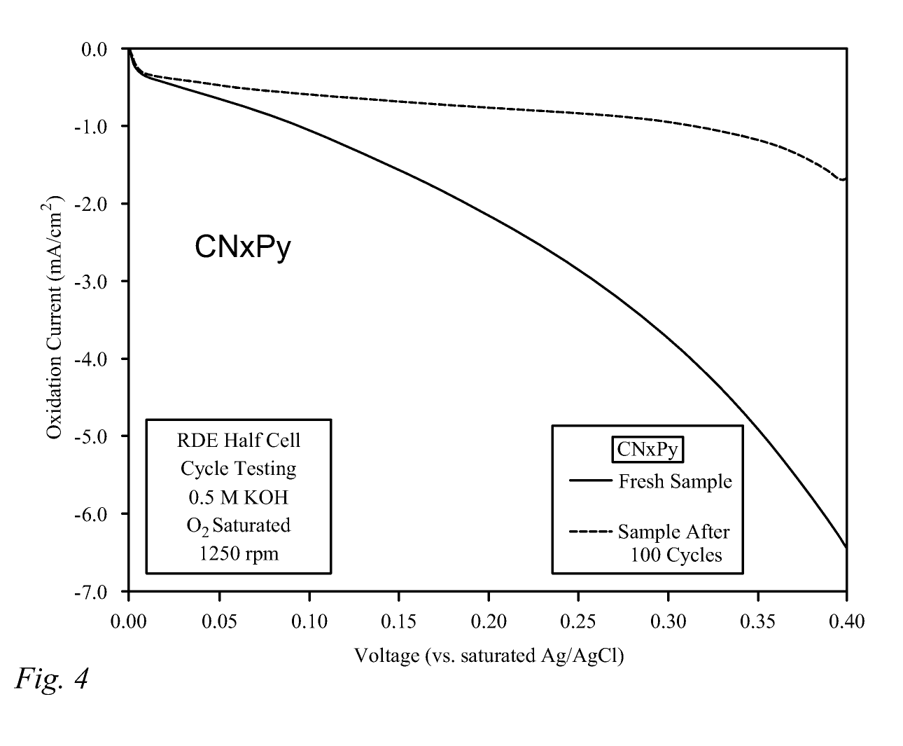

FIG. 4 shows the oxidation current of CNxPy during “charge” cycle in 0.5 M KOH before and after 100 charge/discharge cycles;

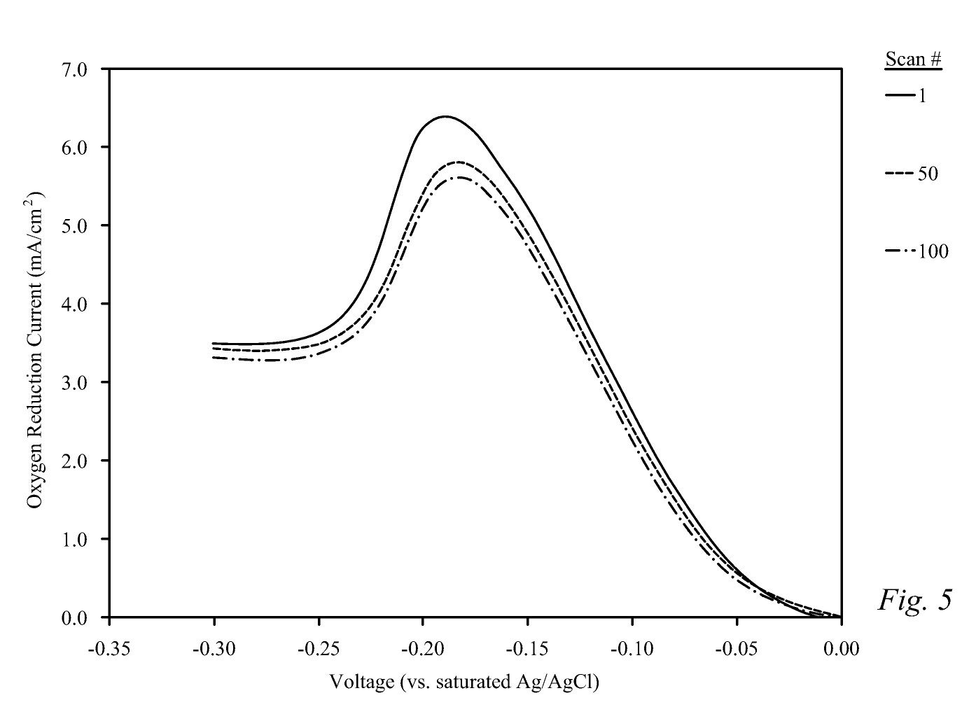

FIG. 5 shows the oxygen reduction current of Fe/CNx before and after 100 charge/discharge cycles in 0.5 M KOH;

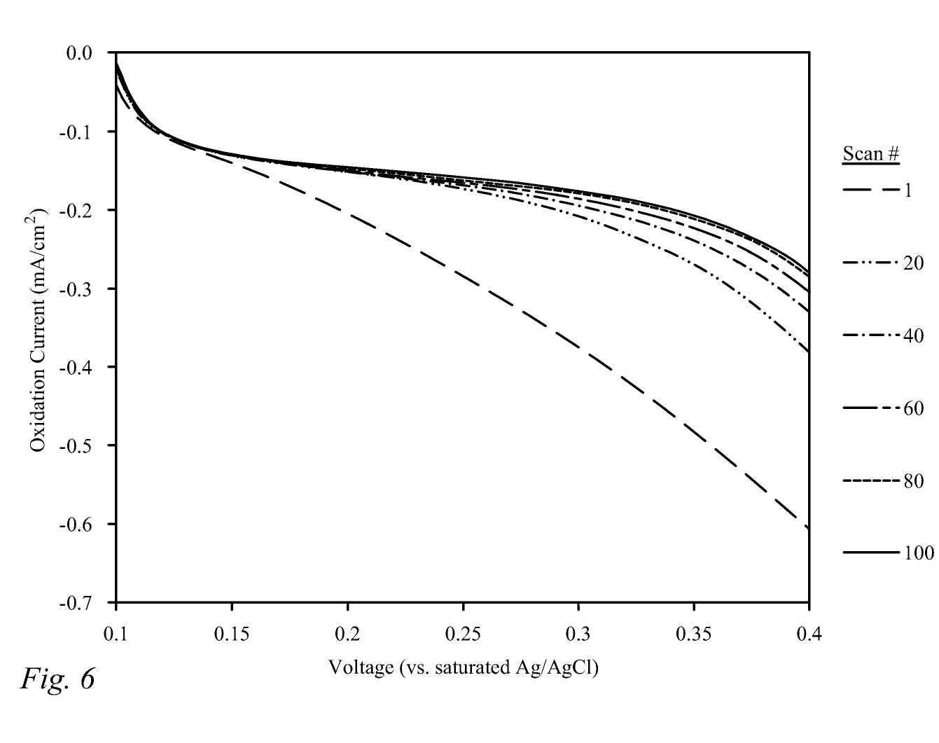

FIG. 6 shows the oxidation current of Fe/CNx during “charge” cycles in 0.5 M KOH during charge/discharge cycle testing over 100 cycles;

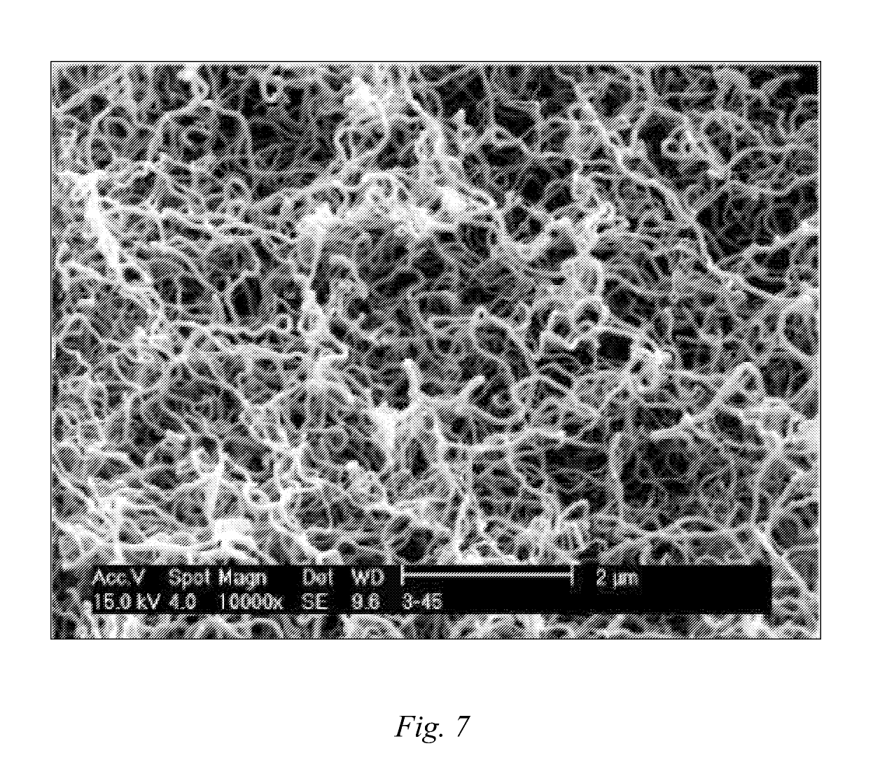

FIG. 7 shows a scanning electron microscope image of anchored CNx fibers grown on a metallic substrate; and

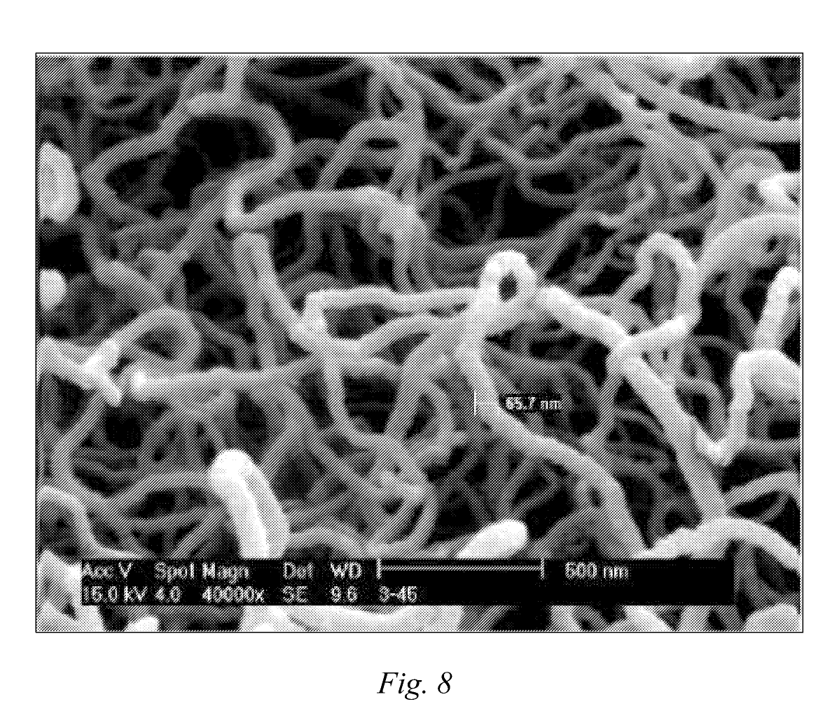

FIG. 8 shows another scanning electron microscope image of anchored CNx fibers grown on a metallic substrate.

These illustrations are provided to assist in the understanding of the exemplary embodiments of a bifunctional electrode design and method of forming the same as described in more detail below and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The disclosed invention for a bifunctional cathode does not use a conventional supported metal catalyst to derive activity for dual oxygen reduction and oxygen evolution activity. Instead, the cathode is based on doped carbon as a catalyst for the ORR and OER. The doped carbon catalyst is not soluble in electrolytes, and therefore can undergo voltage cycling without significant loss of performance. In one embodiment, the first step is to prepare a doped carbon catalyst that is active for both the ORR and the OER. In one approach, active doped carbon can be prepared by first mixing a metal precursor, such as iron or cobalt, with a high surface area support, such as carbon black. In one case, the pre-cursor is impregnated with at least one organic phosphorus and/or organic nitrogen compound. The precursor is then pyrolyzed at high temperature (400°-1200° C.) under an inert or reducing atmosphere containing volatile carbon and/or nitrogen species. In another embodiment, phosphorus is also added as a volatile pre-cursor during pyrolysis. After the pyrolysis, samples may be subjected to additional processing steps, such as milling, heat treatments, and/or acid washes. Acid washes are generally beneficial for applications where the catalyst will be used in an acidic electrolyte, but are optional for neutral and basic electrolyte applications. Washing may also be required if magnesia were used as the high surface area support for the precursor instead of carbon black. Although phosphorus doping generally increases activity and durability for ORR/OER applications, it is also possible to prepare an active catalyst consisting of nitrogen doped carbon, without significant phosphorus content.

In order to construct a device that can operate at higher current densities, the doped-carbon catalyst is preferably coated on a conductive porous support. In one embodiment, the catalyst can be dispersed with a solvent and binder to form an ink The ink is then coated and/or infiltrated in a porous conductive support, such as carbon fiber paper. The coated/infiltrated paper is hot pressed to remove residual solvent and to bind the catalyst to the carbon fiber paper.

In another embodiment, a catalyst precursor, such as iron salt and/or cobalt salt solution mixed with a binder, such as cellulosic binder, can be infiltrated into a porous support, such as carbon fiber paper, nickel mesh, or steel mesh. The support and precursor can then be subjected to one of the pyrolysis conditions described above to form the active doped carbon catalyst fibers that are anchored directly on the support.

### EXAMPLE 1

### EXAMPLE #1

Bi-functional Cathode Testing of CNxPy.

Testing was performed on a doped carbon thin film to demonstrate the kinetic performance and durability of the material as a bi-functional cathode catalyst. The doped carbon, denoted as CNxPy, was prepared using a method described previously in the literature [von Deak 2010]. For activity tests, a catalyst ink was first prepared using 10 mg of catalyst, 2.5 mg of sulfonated tetrafluoroethylene (NAFION™-DuPont) binder (dissolved in ethanol), and 1.6 mL of denatured ethanol. Next, the ink was sonicated for 30 minutes and then 40 mL was deposited in 8 mL aliquots onto a glassy carbon Rotating Disk Electrode (RDE), drying in-between applications for 10 minutes with a heat lamp. The samples were tested using a potentiostat, and a rotating disk electrode (RDE) half-cell set-up that included an Ag/AgCl reference electrode, and a Pt wire counter electrode. The stability of the catalysts was examined through cycle testing in oxygen-saturated 0.5 M KOH. The activities of (a) commercial 20-wt % Pt on Vulcan Carbon XC-72 (from ETEK) and (b) in-house prepared 20-wt % Ag on carbon black are shown for comparison. In this testing, the samples were rotated on the RDE at 1250 rpm and voltage cycled from 0.0 to −0.4 to 0.0 V (discharge cycle), held at 0.0 V for 30 seconds, then the voltage cycled from 0.0 to +0.4 to 0.0 at 10 mV/s (charging cycle). These cycles are similar to the voltage ranges the material would be exposed to in a secondary metal-air battery. For each sample tested, 100 cycles were run. The forward CV scan is reported for the “discharge cycle” with the capacitance subtracted, while the forward scan for the “charge cycle” is reported without adjustment.

FIGS. 1A-1C show the forward “discharge” scan of fresh samples, and the same samples after 100 cycles. The CNxPy catalyst (FIG. 1C) did not degrade significantly during testing, with only a slight increase in overpotential during the first 10 cycles before the activity held steady through 100 cycles. Contrastingly, the Pt (FIG. 1A) and the Ag (FIG. 1B) catalysts lose activity steadily through cycling. This activity loss is likely caused from metal catalyst oxidation and dissolution during the recharge scans. Such a deactivation mechanism cannot occur with CNxPy because it is entirely non-metallic.

The oxidation current produced during “charge” cycles (fresh and after 100 cycles) for the commercial 20-wt % Pt on Vulcan Carbon catalyst is shown in FIG. 2. As seen in FIG. 2 initially, the platinum catalyst shows elevated oxidation current, presumably from oxygen evolution, as the voltage is raised. After 100 cycles, little current is observed beyond what is likely just capacitance (the oxidation cycles do not have the capacitance current subtracted). The lack of significant current indicates that the catalyst is no longer evolving oxygen after 100 cycles at voltages as high as 0.40 V versus Ag/AgCl.

The oxidation current produced during “charge” cycles (fresh and after 100 cycles) for 20-wt % Ag on carbon black is shown in FIG. 3. Initially the catalyst shows elevated oxidation current, presumably from oxygen evolution, as the voltage is swept from 0 to 0.4 V versus Ag/AgCl. Additionally, a pair of peaks are observed from oxidation of the catalyst. After 100 cycles, the current is lower, but some current above the capacitance is clearly present, indicating that the catalyst is less active, but is still evolving some oxygen after 100 cycles.

The oxidation current produced during “charge” cycles (fresh and after 100 cycles) for the CNxPy catalyst is shown in FIG. 4. Initially the catalyst shows very high oxidation current as the voltage is swept from 0 to 0.4 V versus Ag/AgCl. After 100 cycles, the current is lower, but still higher than the deactivated Ag catalyst. This demonstrates that the metal-free CNxPy is a good oxygen evolution catalyst even after 100 cycles, with better activity than platinum or silver.

All of the samples lose performance for oxygen evolution over 100 cycles. The CNxPy oxidation current stabilizes by 100 cycles at a level similar to the fresh platinum or silver OER catalysts, and significantly higher current than deactivated platinum or silver catalysts. It should be noted that some of the initial high oxidation current may be a combination of oxygen evolution and irreversible oxidation of the carbon surface, which apparently has no effect on oxygen reduction.

### EXAMPLE 2

### EXAMPLE #2

Bi-functional Cathode Testing of Fe/CNx. Testing was conducted on a Fe/CNx thin film to determine kinetic performance of the material as a bi-functional cathode catalyst. The Fe/CNx was prepared from the pyrolysis of 2% iron on carbon black in the presence of acetonitrile using a method described previously in the literature [Matter 2006]; however, after the pyrolysis, residual iron was not removed from the carbon by acid washing and thus remained in the sample. For activity tests, a catalyst ink was first prepared using 10 mg of catalyst, 2.5 mg of sulfonated tetrafluoroethylene (NAFION™-DuPont) binder (dissolved in ethanol), and 1.6 mL of denatured ethanol.

Next, the ink was sonicated for 30 minutes and then 40 microliters was deposited in 8 microliter aliquots onto a glassy carbon Rotating Disk Electrode (RDE), drying in-between applications for 10 minutes with a heat lamp. The sample was tested using a potentiostat, and a rotating disk electrode (RDE) half-cell set-up that included an Ag/AgCl reference electrode, and a Pt wire counter electrode. The stability of selected catalysts was examined through cycle testing in oxygen-saturated 0.5 M KOH. The sample was rotated on the RDE at 1250 rpm and voltage cycled from 0.00 to −0.30 to 0.0 V (discharge cycle), held at 0.0 V for 30 seconds, then the voltage cycled from 0.10 to +0.40 to 0.10 at 10 mV/s (charging cycle). These cycles are similar to the voltage ranges the material would be exposed to in a secondary metal-air battery, and 100 consecutive cycles were run. The forward CV scan is reported for the “discharge cycle” with the capacitance subtracted, while the forward scan for the “charge cycle” is reported without adjustment. FIG. 5 shows the forward “discharge” scan of the fresh sample, and the same sample after 100 cycles. The Fe/CNx catalyst did not degrade significantly for oxygen reduction during testing, with only a slight increase in overpotential during the first 10 cycles before the activity held steady through 100 cycles.

The oxidation current produced during “charge” cycles (fresh and up to 100 cycles) for an Fe/CNx catalyst is shown in FIG. 6. Initially the catalyst shows very high oxidation current as the voltage is swept from 0 to 0.4 V versus Ag/AgCl. After 100 cycles, the current is lower, but still significant. It is also important to note that the deactivation is subsiding once 100 cycles have been reached, indicating that the activity will likely be stable at that point. This demonstrates that the Fe/CNx is a good oxygen evolution catalyst, with better activity than platinum or silver, and apparent stability after 100 cycles.

Procedure for Coating Catalyst onto a Conductive Support

In one embodiment, an electrode for oxygen evolution, or a bi-functional electrode for oxygen reduction can be prepared by coating a doped carbon catalyst onto a conductive porous support. The first step is to prepare an ink using 110:11:1200 ratio of catalyst: 60% polytetrafluoroethylene suspension: ethanol. After sonicating the ink for 30 minutes, it is painted with a brush onto a conductive substrate, such as Toray Carbon Fiber Paper (TGP-H-120). After applying the ink, the substrate is dried at 70° C. Further applications of ink are made until about 5 mg/cm2 of catalyst loading is obtained. After the final ink application has dried, the electrode is hot pressed at 250° C. and 500 psi to remove dispersant and bind the catalyst to the substrate.

### Procedure for Growing Carbon Fibers Directly on a Conductive Support

To prepare an electrode for oxygen evolution or a bi-functional electrode, anchored and active doped carbon fibers can alternatively be grown directly on a conductive support. First, a catalyst suspension is prepared by dissolving Co(NO₃)₂ in ethanol. Other metals, such as ferric nitrate could also work. The metal nitrate may be stirred or sonicated to hasten the dissolution process. After dissolution, a polyvinyl butyral type binder is added to the metal nitrate suspension. Other binders, based on methylcellulose or polyvinyl alcohol may be used in addition to improve the suspension characteristics. The composition of the preferred suspension is as follows:

| | | |
|---|---|---|
| Ethanol | 1.985 g | (58% by wt) |
| Co(NO₃)₂×6H₂O | 1.035 g | (30% by wt) |
| BL-1 (Sekisui Binder) | 0.400 g | (12% by wt) |

Once the binder is fully dissolved the suspension is ready to be used. Next, the substrate, such as a steel mesh, a nickel mesh or carbon fiber paper, is coated with the catalyst suspension using a brush. The suspension is then dried in air on the substrate. Once dried, the substrate is annealed in nitrogen at 600° C. for 1 hour. Finally, the substrate is exposed to an atmosphere containing species for growth of doped carbon nanofibers. For example, the substrate can be exposed to acetonitrile vapors at 900° C. for 1 hour to form nitrogen-doped carbon fibers. FIGS. 7 and 8 show examples of doped carbon fibers grown on a stainless steel substrate. The highly porous structure is ideal for an oxygen evolution electrode. Additionally, the fibers are mechanically and electrically anchored to the conductive support. The anchoring is beneficial for maintaining mechanical integrity of the electrode during oxygen evolution, and the electrical connection to the substrate can lower electrical resistance. FIGS. 7 and 8 show an example of an electrode made of anchored catalyst fibers that were prepared from cobalt nitrate. The cobalt nitrate was coated on stainless steel substrate using the procedure described above. The doped carbon fibers were grown at 600° C. using a mixture of carbon monoxide, hydrogen, and ammonia. As seen in FIGS. 7 and 8, the resulting structure has high surface area and pore volume generated from the anchored fibers. These fibers are anchored to the substrate, and are not removed during handling of the substrate or exposure to high gas flow rates. The fibers create relatively small pores compared to large pores present in porous substrates, such as meshes and clothes.

What is claimed then is, in varying embodiments made according to varying methods; is a bifunctional electrode that may include an electrically conductive, gas permeable electrode support and an electrically conductive oxygen reduction and oxygen evolution catalyst comprising nitrogen-doped carbon, wherein nitrogen is present at 0.1 to 10 mole %. The electrode is some embodiments may have at least a partially fibrous material as part of the electrode support, and the electrode support may, in fact, contain fibrous carbon. In other embodiments, the electrode support may include, among other components, a metallic mesh and/or hydrophobic material. This hydrophobic material may include polytetrafluoroethylene.

In terms of structure, in various embodiments, the electrode support may have a plurality of pores having a diameter of from about 1 micron to about 500 microns. The electrode may include embodiments where the nitrogen-doped carbon contains varying amounts of phosphorous and/or iron. Also in terms of structure, the catalyst may include a plurality of pores having a diameter equal to or less than about 1 micron.

Various processes may be used to form the bifunctional electrode. In one process embodiment, the steps may include; mixing a catalyst precursor comprising a metal and high surface area support medium; then pyrolyzing the catalyst precursor in an atmosphere comprising volatile organic carbon species, volatile nitrogen species, and and/or mixtures thereof; then coating an electrically conductive electrode support medium with the pyrolyzed catalyst precursor; and finally, drying the support medium.

The step of pyrolyzing the catalyst precursor may include heating the catalyst precursor to a temperature of about 400° C. to about 1200° C. Components of this process may include having the metal be iron, cobalt, and mixtures thereof; and the support media may include carbon black, magnesia, and mixtures thereof. The pyrolysis atmosphere may include phosphorous.

In other embodiments, various other processes may be used to form the bifunctional electrode. In one, the process steps include applying a coating of a metallic salt to a porous substrate, drying the coating, then pyrolyzing the metallic salt in an atmosphere including volatile organic carbon species, volatile nitrogen species, and/or various mixtures of the same; and finally, cooling the electrode. In such a process, the step of pyrolyzing the catalyst precursor may include heating the catalyst precursor to a temperature of about 400° C. to about 1200° C.

In yet another process to form the bifunctional electrode, the steps may include, mixing a catalyst precursor comprising a metal, a high surface area support medium, a carbon source, and a nitrogen source together. The mixture may then be pyrolized such that the pyrolysis forms a plurality of carbon nanofibers on the high surface area support medium. The process may be completed by cooling the electrode.

Various materials are suitable to serve as the carbon and nitrogen sources, and the following list is provided only by way of example and is not intended to be limiting in any manner. One skilled in the art will know, or be able to realize without undue experimentation that the carbon source can be selected from one or more of the materials including methane, carbon monoxide, polyacrylonitrile; acetonitrile; 1,10 phenanthroline; porphyrins; aniline; polyaniline; pyridine; phthalocyanine; and poly(diallyldimethylammonium chloride). In a similar vein, one skilled in the art will know, or be able to realize without undue experimentation that the nitrogen source can be selected from one or more of the materials including ammonia, polyacrylonitrile; acetonitrile; 1,10 phenanthroline; porphyrins; aniline; polyaniline; pyridine; phthalocyanine; and poly(diallyldimethylammonium chloride.

We claim:

1. A bifunctional electrode comprising;
an electrically conductive, gas permeable electrode support; and
an electrically conductive oxygen reduction and oxygen evolution catalyst comprising nitrogen-doped carbon wherein nitrogen is present at 0.1 to 10 mole %.

2. The electrode according to claim 1, wherein the electrode support is a fibrous material.

3. The electrode according to claim 1, wherein the electrode support is fibrous carbon.

4. The electrode according to claim 1, wherein the electrode support is a metallic mesh.

5. The electrode according to claim 1, wherein the electrode support further comprises a hydrophobic material.

6. The electrode according to claim 5, wherein the hydrophobic material is polytetrafluoroethylene.

7. The electrode according to claim 1, wherein the electrode support further comprises a plurality of electrode support pores having a diameter of from about 1 micron to about 500 microns.

8. The electrode according to claim 7, wherein a plurality of the electrode support pores are at least partially hydrophobic.

9. The electrode according to claim 1, wherein the nitrogen-doped carbon further comprises phosphorous.

10. The electrode according to claim 1, wherein the catalyst further comprises iron.

11. The electrode according to claim 1, wherein the catalyst further comprises a plurality of catalyst pores having a diameter equal to or less than about 1 micron.

12. The electrode according to claim 11, wherein the plurality of catalyst pores are at least partially hydrophilic.

13. A process for forming a bifunctional electrode, comprising the steps of;
a) mixing a catalyst precursor comprising a metal and high surface area support medium;
b) pyrolyzing the catalyst precursor in an atmosphere comprising volatile organic carbon species, volatile nitrogen species, and mixtures thereof;
c) coating an electrically conductive electrode support medium with the pyrolyzed catalyst precursor; and
d) drying the support medium.

14. The process according to claim 13, wherein the step of pyrolyzing the catalyst precursor further comprises heating the catalyst precursor to a temperature of about 400 degrees Celsius to about 1200 degrees Celsius.

15. The process according to claim 13, wherein the metal is selected from the group of metals consisting of iron, cobalt, and mixtures thereof.

16. The process according to claim 13, wherein the support medium is selected from the group of support media consisting of carbon black, magnesia, and mixtures thereof.

17. The process according to claim 13, wherein the atmosphere further comprises phosphorous.

18. A process for forming a bifunctional electrode, comprising the steps of
a) applying a coating of a metallic salt to a porous substrate;
b) drying the coating;
c) pyrolyzing the metallic salt in an atmosphere comprising volatile organic carbon species, volatile nitrogen species, and mixtures thereof; and
d) cooling the electrode.

19. The process according to claim 18, wherein the step of pyrolyzing the catalyst precursor further comprises heating the catalyst precursor to a temperature of about 400 degrees Celsius to about 1200 degrees Celsius.

20. A process for forming a bifunctional electrode, comprising the steps of;
a) mixing a catalyst precursor comprising a metal, a high surface area support medium, a carbon source, and a nitrogen source;
b) pyrolyzing the catalyst precursor, wherein the pyrolysis forms a plurality of carbon nanofibers on the high surface area support medium; and
c) cooling the support medium.

21. The process according to claim 20, wherein the carbon source is a carbon source selected from the group of carbon sources consisting of methane, carbon monoxide, polyacrylonitrile; acetonitrile, 1,10 phenanthroline; porphyrins; aniline; polyaniline; pyridine; phthalocyanine; and poly(diallyldimethylammonium chloride.

22. The process according to claim 20, wherein the nitrogen source is a carbon source selected from the group of carbon sources consisting of ammonia, polyacrylonitrile; acetonitrile, 1,10 phenanthroline; porphyrins; aniline; polyaniline; pyridine; phthalocyanine; and poly(diallyldimethylammonium chloride.
